(19) United States
(12) Patent Application Publication
(10) Pub. No.: US 2017/0287051 A1
(43) Pub. Date: Oct. 5, 2017

(54) Method and Electronic Device for Online Purchasing Membership Services

(71) Applicants: Le Holdings (Beijing) Co., Ltd., Beijing (CN); Lemall (Beijing) Co., Ltd., Beijing (CN)

(72) Inventors: Tianxiang Zheng, Beijing (CN); Yu Bai, Beijing (CN)

(21) Appl. No.: 15/247,316

(22) Filed: Aug. 25, 2016

Related U.S. Application Data
(63) Continuation of application No. PCT/CN2016/089773, filed on Jul. 12, 2016.

(30) Foreign Application Priority Data
Mar. 30, 2016 (CN) 2016101916705

(51) Int. Cl. G06Q 30/06

(52) U.S. Cl. CPC G06Q 30/0635

(57) ABSTRACT

The present disclosure discloses a method and electronic device for online purchasing membership services. The method includes the following steps: an acquisition step for acquiring attribute information of a membership service that a user intends to purchase; an identification step for identifying a behavior that the user adds a membership service commodity that the user intends to purchase into a shopping cart; and a settlement step for settling the amount of money of the membership service paid by the user. According to the present disclosure, by putting the purchased membership service commodity into the shopping cart and then performing settlement, a commodity settlement system of a shopping website can be simplified, and a new settlement system does not need to be additionally set up for the settlement of virtual commodities such as membership services and the like.

### CROSS-REFERENCE TO RELATED APPLICATIONS

This application is a continuation of International Application No. PCT/CN2016/089773, filed Jul. 12, 2016, and claims the priority to Chinese Patent Application No. 201610191670.5 filed Mar. 30, 2016, the disclosures of which are hereby incorporated in their entirety by reference.

### TECHNICAL FIELD

The present disclosure relates to the field of online shopping, and in particular relates to a method and electronic device for online purchasing membership services.

### BACKGROUND

With the development of the Internet network and smart mobile devices, more and more users choose to shop online to obtain goods quickly and easily. Users, through a network platform such as a network mall, can query information of all the products provided by every shop entered in the network mall at any time, for example, prices of the products, etc. At present, there are more and more online shopping malls, for example, from Taobao and Alibaba to JD mall, and then to the current Letv mall, and the competition among the various network malls is increasingly severe.

In the existing shopping websites, the purchase way for virtual commodities such as membership services, etc. is usually direct purchase. That is to say, the payment mode of these virtual commodities is after a user clicks to purchase, then a settlement page for payment is directly displayed. Although this purchase way avoids a step of adding goods to a shopping cart, which seems to simplify the buying process to a certain extent, there are a lot of drawbacks actually. On one hand, in the payment mode, a shopping website needs two sets of payment systems, one corresponding to direct payment, and the other corresponding to payment of goods placed in the shopping cart, which becomes a high pressure and burden for the operation cost and the maintenance cost of the website. On the other hand, network users of online shopping usually choose to purchase multiple goods which include physical and virtual commodities, but they need a separate settlement for virtual commodities such as membership services, etc., so that the users need to pay twice or more times, which causes inconvenience to the operation and deteriorates the user experience.

The information disclosed in the background simply aims to increase the understanding of the overall background of the present disclosure and should not be considered as admitting or implying in any form that the information forms the prior art well known by those of ordinary skill in the art.

### SUMMARY

The present disclosure aims to provide a method and an electronic device for online purchasing membership services where the information of the membership services can be put into a shopping cart and then the purchased membership services are settled through the shopping cart.

The present disclosure further aims to provide a method and an electronic device for online purchasing membership services where membership services as well as derivative products corresponding to the membership services can be conveniently added into a shopping cart, so that the user experience and the operation income of a shopping website are improved.

To this end, an embodiment of the present disclosure provides a method for online purchasing membership services, and the method includes the following steps: an acquisition step for acquiring attribute information of a membership service that a user intends to purchase; an identification step for identifying a behavior that the user adds a membership service commodity that the user intends to purchase, into the shopping cart; and a settlement step for settling the amount of money of the membership service paid by the user.

In a second aspect, an embodiment of the present disclosure provides an electronic device, which includes: at least one processor; and a memory communicably connected with the at least one processor for storing instructions executable by the at least one processor. Execution of the instructions by the at least one processor causes the at least one processor to: acquire attribute information of a membership service that a user intends to purchase; identify a behavior that the user adds a membership service which the user intends to purchase, into a shopping cart; and settle the amount of money of the membership service paid by the user.

In a third aspect, an embodiment of the present disclosure provides a non-transitory computer-readable storage medium. The storage medium stores executable instructions that, when executed by an electronic device, cause the electronic device to: acquire attribute information of a membership service that a user intends to purchase; identify a behavior that a user adds a membership service which the user intends to purchase, into a shopping cart; and settle the amount of money of the membership service paid by the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow schematic diagram of a preferred embodiment of a method for online purchasing membership services according to the present disclosure;

FIG. 2 is a flow schematic diagram of another preferred embodiment of the method for online purchasing membership services according to the present disclosure;

FIG. 3 is a flow schematic diagram of another preferred embodiment of the method for online purchasing membership services according to the present disclosure;

FIG. 4 is a schematic diagram of a device for online purchasing membership services according to the present disclosure; and

FIG. 5 is a block diagram of the structure of an electronic device which can be used for implementing the method for online purchasing membership services according to the present disclosure.

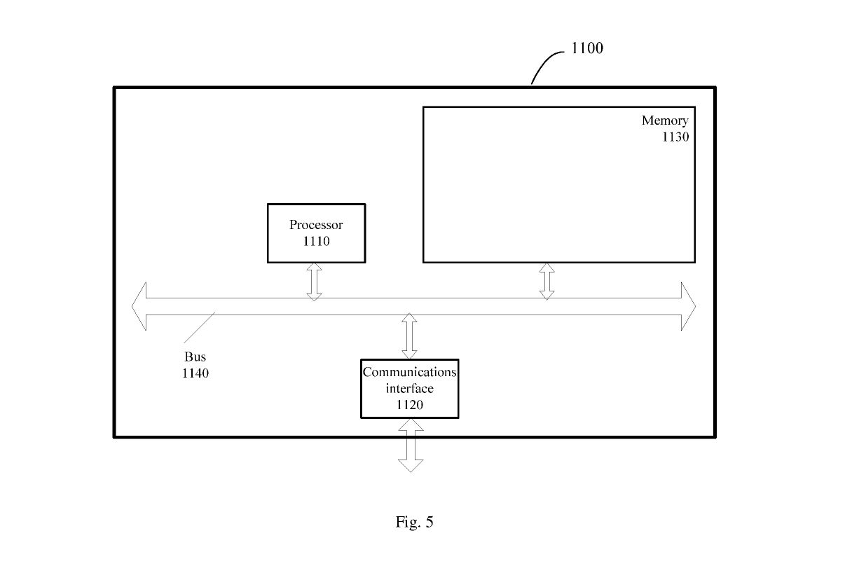

### DETAILED DESCRIPTION

Hereinafter, the specific embodiments of the present disclosure will be described in details with reference to the drawings, but it should be appreciated that the protection scope of the present disclosure is not limited by the specific embodiments.

Unless otherwise expressly stated, the term “comprise” or its alternate, for example “contain” or “include”, etc. will be understood as comprising the stated elements or components without excluding other elements or other components.

### Embodiment 1

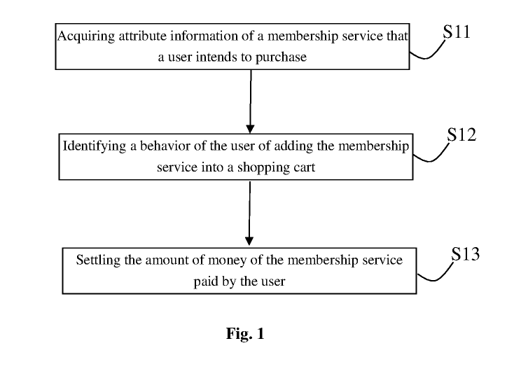

FIG. 1 shows a preferred embodiment of a method for online purchasing membership services according to the present disclosure. As shown in FIG. 1, when a user browses a shopping website, if the user intends to purchase a membership service on the website, the user selects the attribute information of the membership service, such as the price, quantity and type of the membership service, the duration of the membership service and the like. In S11, an acquisition module of a server acquires these attribute information of the membership service that the user intends to purchase. Next, the difference between the method and the conventional way of purchasing membership services lies in that in the method according to the present disclosure, when a user selects a purchased membership service, the membership service will be added into a shopping cart, and then in S12, an identification module of the server will identify a behavior of the user of adding the membership service into the shopping cart. Next, the user pays for the membership service in the shopping cart, and in S13, a settlement module of the server charges and settles the payment, so that the whole purchasing process of the membership service is completed.

### Embodiment 2

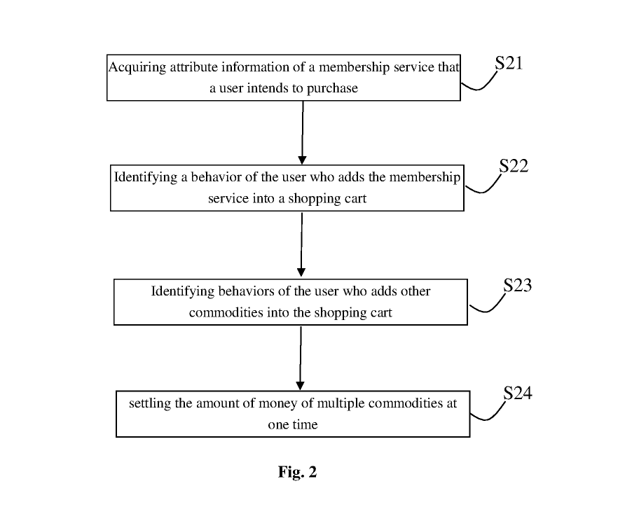

FIG. 2 shows another preferred embodiment of the method for online purchasing membership services according to the present disclosure. As shown in FIG. 2, when a user browses a shopping website, if the user intends to purchase a membership service on the website, the user selects the attribute information of the membership service, such as the price, quantity and type of the membership service, the duration of the membership service and the like. In S21, the server acquires these attribute information of the membership service that the user intends to purchase. Next, in the method according to the present disclosure, when the user selects the purchased membership service, the membership service will be added into a shopping cart, and then in S22, the server will identify a behavior of the user of adding the membership service into the shopping cart. Generally, the user will purchase multiple commodities at the same time when browsing a shopping website, other commodities are added into the shopping cart in a similar way, and then in S23, an behavior that the user adds the other commodities into the shopping cart is identified. It should be noted that, there is no compulsive sequence relationship for S22 and S23, so that S22 and S23 can be mutually exchanged in order, and step numbers are only used for distinguishing different steps rather than expressing that the present disclosure must be executed according to the sequence. Next, the user pays for the membership service as well as other commodities in the shopping cart, and in S24, the server charges and settles the payment, so that the whole purchasing process of the membership service and the other commodities is completed.

### Embodiment 3

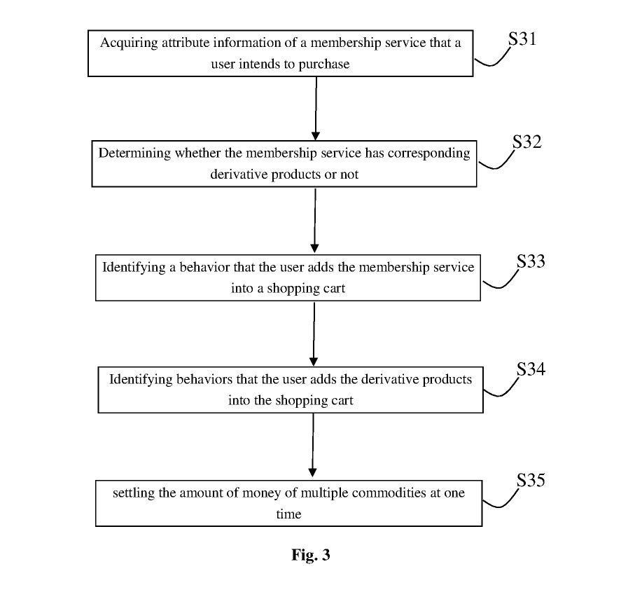

FIG. 3 shows another preferred embodiment of the method for online purchasing membership services according to the present disclosure. As shown in FIG. 3, when a user browses a shopping website, if the user intends to purchase a membership service on the website, the user selects the attribute information of the membership service, such as the price, quantity and type of the membership service, the duration of the membership service and the like. In S31, the server acquires these attribute information of the membership service that the user intends to purchase.

Next, in S32, the server will determine whether the membership service has corresponding derivative products based on the attribute information; and a commodity description page of one or more derivative products is displayed on a commodity description page of the membership service.

Next, in the method according to an embodiment of the present disclosure, when the user selects the to-be-purchased membership service, the membership service will be added into a shopping cart, and then in S33, the server will identify a behavior of the user who adds the membership service into the shopping cart; and in S34, the behaviors that the user adds the derivative products into the shopping cart is identified.

It should be noted that the sequence of S32 and S33 can be exchanged, and the essence of the present disclosure will not be influenced.

As mentioned above, multiple derivative products associated with the membership service may be displayed on the commodity description page of the membership service, and the derivative products may be directly added into the shopping cart, or may be added into the shopping cart after entering product description pages of the derivative products by clicking on links of the derivative products. Optionally, the description information of the derivative products may be popped out by the system after or during selection of the attribute information including session, duration and the like of the membership service, and at this moment, the user can click on the links of the derivative products or directly put them into the shopping cart.

Next, the user pays for the membership service and the derivative products in the shopping cart, and in S35, the server charges and settles the payment, so that the whole purchasing process of the membership service and the derivative products is completed. Certainly, in the present embodiment, the user also can add other commodities into the shopping cart and then perform settlement process.

Preferably, in the present embodiment, whether the membership service has corresponding derivative products can be determined according to the attribute information; and the information of the derivative products can be displayed on the website used for selling the membership service. The attribute information includes one or more of the merchant information, name, content, quantity and price of the membership service. The derivative products include a mobile phone, a television and supporting services.

For example, if a user purchases a one-year VIP membership service of LeTV, the derivative products of LeTV set associated with the VIP membership service may be bound or recommended to the VIP membership service, the user may select a television corresponding to the service and put it into the shopping cart together with the VIP membership service, thereby performing purchasing process. Or, the VIP membership service and the other supporting membership level (a virtual product as well) are associated products, and then the user can add the supporting membership level into the shopping cart for purchasing.

Preferably, in the present embodiment, the method also includes: pre-storing a relationship between the membership service and the corresponding derivative products; and determining whether the membership service has corresponding derivative products according to the relationship.

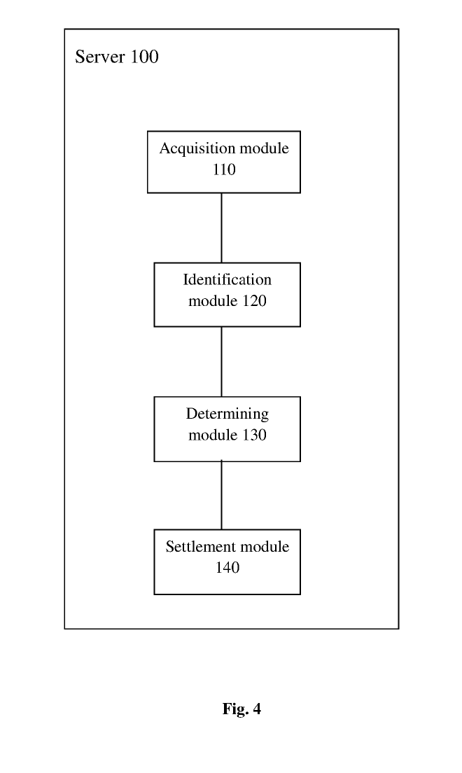

FIG. 4 is a schematic diagram of a device for online purchasing membership services according to the present disclosure, wherein a server 100 of a shopping website includes: an acquisition module 110, which is used for acquiring attribute information of a membership service that a user intends to purchase; an identification module 120, which is connected with the acquisition module 110 and is used for determining a behavior of the user who adds the purchased membership service commodity into a shopping cart; and a settlement module 140, which is used for settling the amount of money of the membership service paid by the user.

Preferably, the server 100 also includes a determining module 130, which is used for determining whether the membership service has corresponding derivative products or not according to the attribute information of the membership service.

The working mode of the abovementioned module has been described in detail in the embodiments 1-3, and will not be repeated hereinafter.

To sum up, according to the method for online purchasing membership services, provided by the present disclosure, by putting the purchased membership service commodity into the shopping cart and then performing settlement, a commodity settlement system of a shopping website can be simplified, and a new settlement system does not need to be additionally set up for the settlement of virtual commodities such as membership services and the like, so that the labor force of background maintenance workers is greatly saved. In addition, according to the method for online purchasing membership services, provided by the disclosure, when the user purchase a membership service, the derivative products associated with the membership service also can be selected and purchased, so that the operation income of the shopping website is greatly increased, the user can settle the membership service and the derivative products thereof together at the same time, and the shopping experience of the user is facilitated.

FIG. 3 is a block diagram of the structure of an electronic device capable of executing the method for online purchasing membership services according to the present disclosure. The network device 1100 may be a host server with computing power, a personal computer (PC), or a portable computer or terminal or the like. The specific embodiments of the present disclosure do not limit the specific implementation of a computing node.

The network device 1100 includes a processor 1110, a communications interface 1120, a memory (memory array) 1130 and a bus 1140, wherein the processor 1110, the communications interface 1120 and the memory 1130 achieve intercommunication through the bus 1140.

The communications interface 1120 is used for communicating with a network element, wherein the network element includes, for example, a virtual machine management center, a shared storage and the like.

The processor 1110 is used for executing a program. The processor 1110 may be a central processing unit (CPU), or an ASIC (Application Specific Integrated Circuit), or one or more integrated circuits configured to implement the embodiments of the present disclosure.

The memory 1130 is used for storing files. The memory 1130 may include a high-speed RAM memory, and may also include a non-volatile memory, for example, at least one disk memory. The memory 1130 may also be a memory array. The memory 1130 may also be partitioned into blocks, and the blocks may be combined into a virtual volume according to a certain rule.

In a possible embodiment, the abovementioned program may be a program code including a computer operation instruction. Such computer operation instructions can be stored in a non-transitory computer-readable storage medium. The computer operation instructions can be executed by a processor or by an electronic device including a processor. The computer operation instructions may be configured to implement the abovementioned method for online purchasing membership services, which causes the processor or causes the electronic device to: acquire attribute information of a membership service that a user intends to purchase; identify a behavior that the user adds a membership service which the user intends to purchase, into a shopping cart; and settle the amount of money of the membership service paid by the user.

Those skilled in the art should understand that the embodiments of the present disclosure may be provided as a method, a system or a computer program product. Therefore, the present disclosure may adopt the form of a hardware embodiment, a software embodiment, or an embodiment combining software and hardware. Moreover, the present disclosure may adopt the form of a computer program product implemented on one or more computer available storage media (including but not limited to a disk memory and an optical memory, etc.) including a computer available program code.

It will be appreciated that in the device and/or method of the present disclosure, each of the steps may be executed sequentially according to an order described in the description, but can also be executed in parallel or independently with one another as long as the same or equivalent technical effect is achieved.

The aforementioned descriptions of the specific exemplary embodiments of the present disclosure are for the purposes of explanation and illustration. These descriptions are not intended to limit the present disclosure as a disclosed exact form, and it is clear that, in accordance with the abovementioned instructions, a lot of changes and changes can be carried out. The purpose of selecting and describing the exemplary embodiments is to interpret the specific principles and practical application of the present disclosure, so that those skilled in the art can implement and use a variety of different exemplary embodiments and a variety of selections and changes of the present disclosure. The scope of the present disclosure is intended to be defined by the claims and equivalent forms thereof.

What is claimed is:

1. A method for online purchasing membership services, adapted to be used by a server, said method comprising:
an acquisition step for acquiring attribute information of a membership service that a user intends to purchase;
an identification step for identifying a behavior that the user adds a membership service which the user intends to purchase, into a shopping cart; and
a settlement step for settling the amount of money of the membership service paid by the user.

2. The method according to claim 1, further comprising:
determining whether the membership service has corresponding derivative products, according to the attribute information; and
displaying information of the derivative products on a same webpage as the one that is showed for selling the membership service.

3. The method according to claim 1, further comprising:
pre-storing a relationship between the membership service and the corresponding derivative products; and
determining whether the membership service has corresponding derivative products, according to the relationship.

4. The method according to claim 1, wherein the attribute information comprises at least one of following: the merchant information of the membership service, name of the membership service, content of the membership service, quantity of the membership service, and price of the membership service.

5. The method according to claim 2, wherein the derivative products comprise one or more of a mobile phone, a television, and supporting services.

6. The method according to claim 2, further comprising:
before the settlement step, a step for further adding the derivative products into the shopping cart.

7. An electronic device, comprising:
at least one processor; and
a memory communicably connected with the at least one processor for storing instructions executable by the at least one processor, wherein execution of the instructions by the at least one processor causes the at least one processor to:
acquire attribute information of a membership service that a user intends to purchase;
identify a behavior that the user adds a membership service which the user intends to purchase, into a shopping cart; and
settle the amount of money of the membership service paid by the user.

8. The electronic device according to claim 7, wherein execution of the instructions by the at least one processor further causes the at least one processor to:
determine whether the membership service has corresponding derivative products, according to the attribute information; and
display information of the derivative products on a same webpage as the one that is showed for selling the membership service.

9. The electronic device according to claim 7, wherein execution of the instructions by the at least one processor further causes the at least one processor to:
pre-store a relationship between the membership service and the corresponding derivative products; and
determine whether the membership service has corresponding derivative products, according to the relationship.

10. The electronic device according to claim 7, wherein the attribute information comprises at least one of following: the merchant information of the membership service, name of the membership service, content of the membership service, quantity of the membership service, and price of the membership service.

11. The electronic device according to claim 8, wherein the derivative products comprise one or more of a mobile phone, a television, and supporting services.

12. The electronic device according to claim 8, wherein execution of the instructions by the at least one processor further causes the at least one processor to:
before settling the amount of money of the membership service paid by the user, further add the derivative products into the shopping cart.

13. A non-transitory computer-readable storage medium storing executable instructions thereon, which, when executed by an electronic device, cause the electronic device to:
acquire attribute information of a membership service that a user intends to purchase;
identify a behavior that the user adds a membership service which the user intends to purchase, into a shopping cart; and
settle the amount of money of the membership service paid by the user.

14. The non-transitory computer-readable storage medium according to claim 13, wherein execution of the instruction further causes the electronic device to:
determine whether the membership service has corresponding derivative products, according to the attribute information; and
display information of the derivative products on a same webpage as the one that is showed for selling the membership service.

15. The non-transitory computer-readable storage medium according to claim 13, wherein execution of the instructions further causes the electronic device to:
pre-store a relationship between the membership service and the corresponding derivative products; and
determine whether the membership service has corresponding derivative products, according to the relationship.

16. The non-transitory computer-readable storage medium according to claim 13, wherein the attribute information comprises at least one of following: the merchant information of the membership service, name of the membership service, content of the membership service, quantity of the membership service, and price of the membership service.

17. The non-transitory computer-readable storage medium according to claim 14, wherein the derivative products comprise one or more of a mobile phone, a television, and supporting services.

18. The non-transitory computer-readable storage medium according to claim 14, wherein execution of the instructions further causes the electronic device to:
before settling the amount of money of the membership service paid by the user, further add the derivative products into the shopping cart.
